(19) United States
(12) Patent Application Publication
(10) Pub. No.: US 2010/0138418 A1
(43) Pub. Date: Jun. 3, 2010

(54) METHOD AND APPARATUS FOR REPRODUCING CONTENT BY USING METADATA

(75) Inventors: Sun-hee YOUM, Seoul (KR); Ju-hee SEO, Hwaseong-si (KR); Seung-ji YANG, Seongnam-si (KR); Hwa-jung KIM, Suwon-si (KR); Woo-sung SHIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/626,766

(22) Filed: Nov. 27, 2009

(30) Foreign Application Priority Data
Nov. 28, 2008 (KR) 10-2008-0119958

(51) Int. Cl. G06F 17/30; G06N 5/02

(52) U.S. Cl. 707/736; 706/48; 707/E17.01; 707/E17.114; 707/609

(57) ABSTRACT

A method and apparatus for reproducing content by using metadata are provided. In the method, a metadata file and a content file are obtained, wherein the metadata file comprises at least one of learned content reproduction pattern information and reproduction management information; the content file is reproduced based on the at least one of the learned content reproduction pattern information and the reproduction management information of the metadata file; and the metadata file is updated based on the at least one of the learned content reproduction pattern information and the reproduction management information.

### CROSS-REFERENCE TO RELATED PATENT APPLICATION

This application claims priority from Korean Patent Application No. 10-2008-0119958, filed on Nov. 28, 2008 in the Korean Intellectual Property Office, the disclosure of which is incorporated herein in its entirety by reference.

### BACKGROUND

1. Field

Methods and apparatuses consistent with the inventive concept relate to reproducing content, and more particularly, to reproducing content by using metadata containing learned content reproduction pattern information and reproduction management information.

2. Description of the Related Art

In the related art, content described in the form of a single file is consumed for a single function. However, as advances in digital multimedia technology have increased user convenience, for example, by effectively storing and managing content, sharing content between user terminal devices, and accumulating content consumption patterns, user demand for consuming content in various ways has increased accordingly.

In the related art, a content file described in an International Standardization Organization (ISO) file format is utilized for recording and reproducing of media data. Also, metadata related to the content file is additionally stored and managed in a file in which the media data is stored.

Accordingly, in order to further store additional metadata related to the content file, the entire content file that includes the already stored metadata should be readjusted. Also, it is difficult to accumulate consumption patterns related to the content file since the metadata is subject to the content file.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide a method and apparatus for reproducing content by using a metadata file that includes learned content reproduction pattern information and reproduction management information.

According to an aspect of an exemplary embodiment, there is provided a method of reproducing content, the method including obtaining a metadata file and a content file from a content providing server or a content providing medium, wherein the metadata file may include at least one of learned content reproduction pattern information and reproduction management information; reproducing the content file based on at least one of the learned content reproduction pattern information and the reproduction management information of the metadata file; and updating the metadata file based on the at least one of the learned content reproduction pattern information and the reproduction management information.

When a plurality of metadata files related to the same content file are obtained from the content providing server or the content providing medium, the method may further include combining the metadata files into one metadata file.

As the learned content reproduction pattern information, the metadata file may include at least one of information regarding content reproduction environments of users, and the users' evaluation of content. As the reproduction management information, the metadata file may include at least one of bookmark information regarding a specific point or section of the content, significant chapter information of the content, and direct access information indicating a point of the content that was last reproduced.

The metadata file may be described using an ISO file format.

The metadata file and the content file may exist separately from each other, and both the metadata file and the content file may include reference information referring to each other.

The reference information may include an identification or a uniform resource locator (URL) of either the metadata file or the content file.

The method may further include providing the updated metadata file to either at least one of the content providing server and another content reproducing apparatus or the content providing medium.

The method may further include generating the metadata file that includes at least one of the learned content reproduction pattern information and the reproduction management information.

The method may further include transmitting the generated metadata file to either at least one of the content providing server and another content reproducing apparatus or the content providing medium.

According to an aspect of another exemplary embodiment, there is provided a computer readable recording medium having recorded thereon a computer program for executing the above method.

According to an aspect of another exemplary embodiment, there is provided an apparatus for reproducing contents, the apparatus including a file obtaining unit obtaining a metadata file and a content file from a content providing server or a content providing medium, wherein the metadata file includes at least one of learned content reproduction pattern information and reproduction management information; a reproducing unit reproducing the content file based on at least one of the learned content reproduction pattern information and the reproduction management information of the metadata file; and an update unit updating the metadata file based on the at least one of the learned content reproduction pattern information and the reproduction management information.

### BRIEF DESCRIPTION OF THE DRAWINGS

The above and other features and aspects of the exemplary embodiments will be described in detail with reference to the attached drawings in which:

FIG. 1 schematically illustrates a service of reproducing content by using metadata according to an exemplary embodiment;

FIG. 2 is a block diagram illustrating the construction of a metadata file described in an ISO file format according to an exemplary embodiment;

FIG. 3 illustrates a user scenario using a metadata file according to an exemplary embodiment;

FIG. 4 is a flowchart illustrating a method of reproducing content by using metadata according to an exemplary embodiment; and

FIG. 5 is a block diagram of an apparatus for reproducing content by using metadata according to an exemplary embodiment.

### DETAILED DESCRIPTION OF EXEMPLARY EMBODIMENTS

Hereinafter, exemplary embodiments will be described in detail with reference to the accompanying drawings. Like reference numerals denote like elements throughout the drawings. The size of each element in the drawings may be exaggerated for clarity.

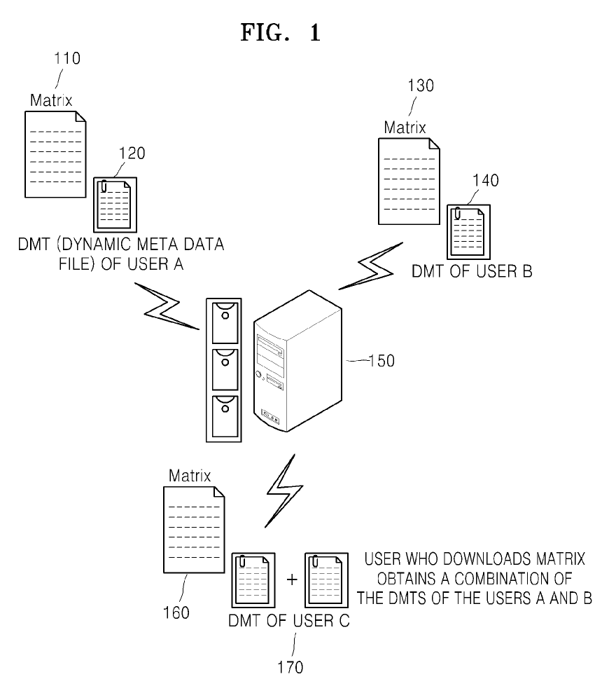

FIG. 1 schematically illustrates a service of reproducing content by using metadata according to an exemplary embodiment.

In the current exemplary embodiment, an apparatus which can be used to consume general multimedia data may be a content reproducing apparatus 500 as illustrated in FIG. 5. The operations of the content reproducing apparatus 500, which will be described in detail later with reference to FIG. 5, will now be described in relation to the service illustrated in FIG. 1.

Referring to FIG. 1, according to an exemplary embodiment, metadata 120, 140, and 170 are created, stored and moved separately from content files 110, 130, and 160, respectively, that are to be consumed.

In the current exemplary embodiment, the content files 110, 130, and 160 are related to a movie entitled “The Matrix”. In the current exemplary embodiment, the content reproducing apparatus 500 may create information enabling improved content consumption in the form of dynamic metadata files (DMT) 120, 140, and 170. The content reproducing apparatus 500 may obtain the metadata files 120, 140, and 170 from a content providing server 150 or a content providing medium (not shown), or may directly obtain the metadata files 120, 140, and 170 from a terminal, e.g., another content reproducing apparatus. The information in the metadata files 120, 140, and 170 is used when the content files 110, 130, and 160 are reproduced. In the current exemplary embodiment, the metadata files 120, 140, and 170 include information regarding characteristics that a user may use in order to reproduce the content. Use of the metadata files 120, 140, and 170 may lead to improved content consumption. For example, the metadata files 120, 140, and 170 may include various information, such as video parameters and user preferences.

In an exemplary embodiment, a metadata file and a content file exist separately from each other but both include reference information referring to each other. Such a metadata file and a content file will be hereinafter described based on an ISO file format but it would be apparent to those of ordinary skill in the art that the exemplary embodiments are not limited thereto and another file format may also be utilized.

Although not shown, content reproducing apparatuses of respective users, such as the content reproducing apparatus 500, obtain the content files 110, 130, and 160 related to the movie entitled “The Matrix” from the content providing server 150. Further, although FIG. 1 illustrates that the content files 110, 130, and 160 are obtained from the content providing server 150, they may also be obtained from the content providing medium or another content reproducing apparatus.

Also, the metadata files 120, 140, and 170 may be obtained either from the content providing server 150 that provides the content files 110, 130, and 160, or from another server. Alternatively, the metadata files 120, 140, and 170 may be respectively, directly created by users, or may be obtained from a content providing medium or another content reproducing apparatus.

The content reproducing apparatus 500 may use information included in a metadata file in order to reproduce an obtained content file. Alternatively, after reproducing the content file, the content reproducing apparatus 500 may update the metadata file to reflect content reproduction pattern information and reproduction management information related to the reproducing of the content file.

Also, the content reproducing apparatus 500 may provide the updated metadata file to the content providing server 150 or store it in the content providing medium in order for a user to share the updated metadata file with other users.

That is, while watching the movie entitled “The Matrix”, a user A may use optimal video parameters and information regarding main scenes included in the metadata file 120 received from the content providing server 150, or may generate new metadata by modifying video parameters or updating information regarding main scenes that the user A selects. The new metadata may be delivered to the content providing server 150 so that it can be shared with other users B and C. Also, the new metadata may be shared or stored via a content providing medium.

Alternatively, when receiving a plurality of metadata files related to the same content file from the content providing server 150 or the content providing medium, the content reproducing apparatus 500 may combine the metadata files into a single metadata file. For example, if the user C receives the metadata file 140 of the user B, which was created in a similar manner to the metadata file 120 of the user A, the two metadata files 120 and 140 may be combined into the metadata file 170. Also, if the user C already has the metadata file 170 created by the user C and receives one of the metadata file 120 of the user A and the metadata file 140 of the user B, then the metadata file 170 may be combined with either one of the metadata files 120 and 140.

A plurality of metadata files may be combined in various ways as described below.

First, when two pieces of metadata information are present in the same field, they may be separately stored. In this case, a storage space should be large. Accordingly, a storage space related to information, such as user preferences or consumption patterns which need to be accumulated, should be sufficiently allocated so that various information can be accumulated in the storage space. However, when two pieces of metadata information are present in the same field, only one of them may be stored and the other metadata information may be discarded. In this case, a predetermined fixed storage space for the field is used and the value thereof is changed. In general, the pieces of the metadata information may be user video parameter information. In this case, either a user interface may be provided to a user so that the user may select desired information from among the pieces of the metadata information, or one piece of metadata information is automatically selected from among the pieces of the metadata information according to predetermined information, e.g., the order in which the pieces of the metadata information were generated.

When two pieces of metadata information are present in different fields, both the two pieces of the metadata information may exist in the combined metadata file. Accordingly, the content reproducing apparatus 500 according to the current exemplary embodiment may combine metadata files into one metadata file in order to unify different users' content consumption patterns for the same content. Also, a metadata file may be updated with a combined metadata file in order to provide a metadata file including a combination of the different users' content consumption patterns. As described above, the content reproducing apparatus 500 may provide the updated metadata file to either the content providing server or the content providing medium, thereby allowing a user to share the updated metadata file with other users.

According to the current exemplary embodiment, the content reproducing apparatus 500 can conveniently store information related to content consumption in the form of a separate metadata file. The content reproducing apparatus 500 can also easily analyze a content consumption pattern by analyzing only metadata files including additional data, such as a content consumption pattern, without having to separate metadata from a content file. The content reproducing apparatus 500 is also capable of obtaining accumulated information regarding content consumption patterns by combining different users' content consumption patterns for the same content.

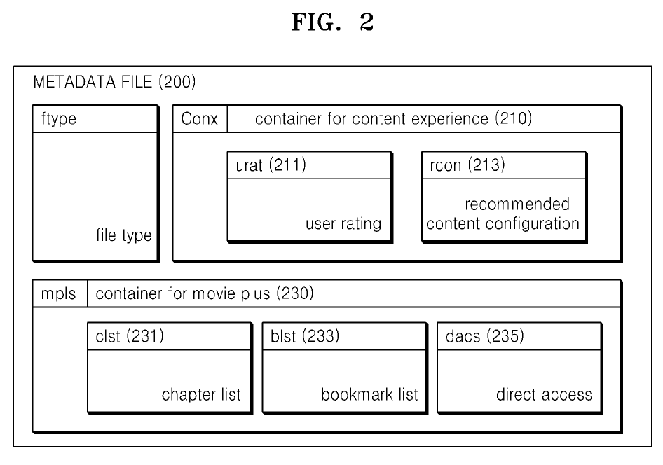

FIG. 2 is a block diagram illustrating the construction of a metadata file 200 described in an ISO file format according to an exemplary embodiment. The ISO file format illustrated in FIG. 2 is merely an example, and the exemplary embodiments are not limited thereto. The construction of the metadata file 200 will now be described based on the ISO file format of FIG. 2.

The metadata file 200 and a content file (not shown) exist separately from each other but both include reference information referring to each other. Each piece of the reference information may include an identification or a universal resource locator (URL) of one of the metadata file 200 and the content file but the exemplary embodiments are not limited thereto.

In the current exemplary embodiment, the metadata file 200 includes learned content reproduction pattern information, reproduction management information, etc. In one exemplary embodiment, the metadata file 200 includes a plurality of containers. That is, the metadata file 200 may include an ‘ftype’ container that includes information identifying the file type as the metadata file 200, a ‘conx’ (content experience) container 210 that includes content reproduction pattern information, and an ‘mpls’ (movie plus) container 230 that includes reproduction management information. Alternatively, further information regarding the metadata file 200 may be described using another container.

In the current exemplary embodiment, each of the above containers stores additional factors and this is illustrated in the form of boxes in FIG. 2. Although similar factors are categorized in units of containers, the exemplary embodiment is not limited to such a container or box.

Specifically, the ‘conx’ container 210 includes an ‘urat’ (user rating) box 211 and an ‘rcon’ (recommended content configuration) box 213. The ‘urat’ box 211 may include information regarding users' evaluation of content and a number of times the content is reproduced, and the ‘rcon’ box 213 includes information regarding environments in which the users can respectively reproduce the content. More specifically, the ‘rcon’ box 213 may include screen information (a screen ratio, etc.), audio information (volume, etc.), subtitle information (font, subtitle location, language, etc.), running time, the type of a reproducing apparatus, and so on.

In an exemplary embodiment, the ‘urat’ box 211 may be used to share information, such as user content preference, and the ‘rcon’ box 213 may be used to maintain content reproduction environment information regardless of the difference of content reproducing apparatus.

The ‘mpls’ container 230 includes information related to a function of increasing user convenience when a user reproduces and manages content. For example, the ‘mpls’ container 230 may include a ‘clst’ (chapter list) box 231, a ‘blst’ (bookmark list) box 233 and a ‘dacs’ (direct access) box 235.

The ‘clst’ box 231 includes significant chapter information of the content. The ‘blst’ box 233 includes bookmark information regarding a specific point or section of the content. The ‘dacs’ box 235 includes direct access information indicating a point of the content that was last reproduced.

Other various information may be stored and consumed in the form of metadata as described above.

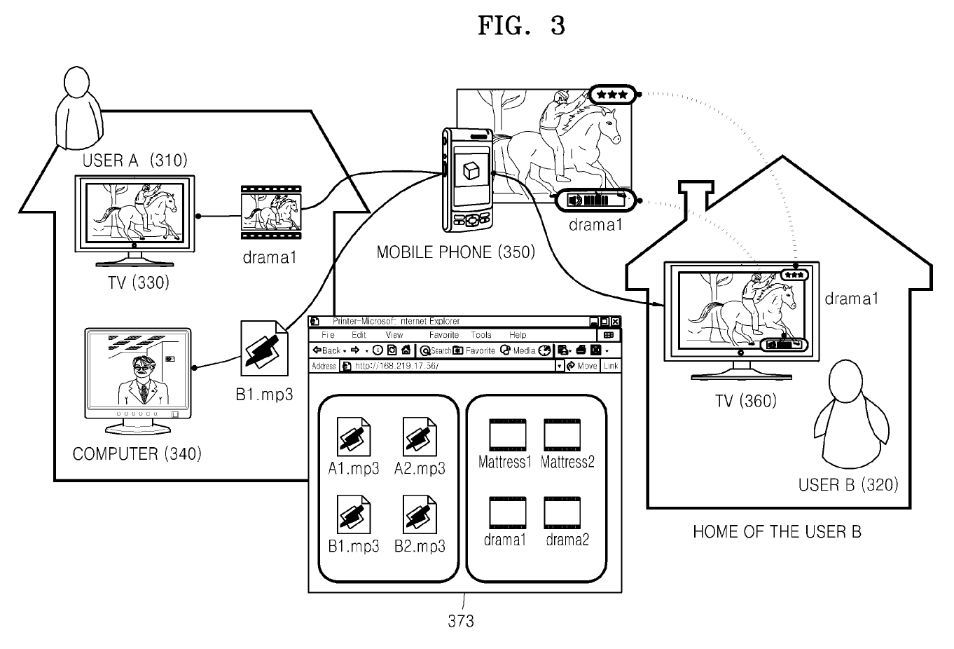

FIG. 3 illustrates a user scenario using a metadata file, such as the metadata file 200 of FIG. 2, according to an exemplary embodiment. A user A 310 may store a content file in a mobile phone 350 in order to reproduce the content file while moving. Here, the content may be a drama or movie content downloaded from a television (TV) 330 at the home of the user A 310, or an MPEG-1 Audio Layer 3 (MP3) file for learning a language or MP3 music content downloaded from a computer 340 at the home of the user A.

In the mobile phone 350, reproduction pattern information and reproduction management information of content that is to be reproduced are stored in a metadata file regarding the content. When receiving the metadata file together with a content file, the mobile phone 350 combines the reproduction pattern information and reproduction management information with the metadata file. Different user content consumption patterns for the same content may be combined by combining reproduction pattern information and reproduction management information with a metadata file, and thus, the metadata file of the content may have accumulated information.

The reproduction pattern information of content, which is created by the mobile phone 350 or which is obtained from the above-described combination, may be described using, for example, the ‘urat’ box 211 and the ‘rcon’ box 213 of the metadata file 200 illustrated in FIG. 2. In detail, the ‘urat’ box 211 may include information, such as the evaluation of users who reproduced the content regarding the content and the number of times that the content is reproduced. The ‘rcon’ box 213 may include content reproduction environment information of users, such as screen information, audio information, font, subtitle information, a running time, and the type of reproducing apparatus.

The mobile phone 350 may provide a metadata file that is obtained from the above-described combination or that is newly created, either to a content providing server, such as the TV 330 and the computer 340, or to a content providing medium, thereby allowing a user to share the metadata file with other users. Alternatively, the mobile phone 350 may allow the user to directly share the metadata file with other users.

For example, when content has been recorded at a low audio level and thus content needs to be always reproduced at a maximum audio level, the mobile phone 350 may receive a metadata file including information regarding the maximum audio level from the computer 340 and reproduce the content at the maximum audio level based on the information. When the mobile phone 350 generates the metadata file including information regarding the maximum audio level, the mobile phone 350 may directly transmit the metadata file to a TV 360 of a user B 320 in order for the user A to share the information regarding the maximum audio level with the user B 320. That is, the maximum audio level may be applied to any other device capable of reproducing the content.

As illustrated in FIG. 3, the user B 320 may receive a metadata file containing the evaluation of the user A 310, who reproduced content, from the mobile phone 350 via the TV 360 of the user B 320, and use the content consumption pattern of the user A 310. The evaluation of user A 310 includes information regarding the content and content reproduction environment information.

In an exemplary embodiment, if the user A 310 connects the mobile phone 350 to the computer 340 in order to transmit MP3 content for learning a language from the computer 340 to the mobile phone 350, then a plurality of pieces of MP3 content for learning a language, which are mainly to be transmitted to the mobile phone 350, are first aligned and output from among a plurality of pieces of content stored in the computer 340 (373). The computer 340 is capable of first aligning and outputting a plurality of pieces of MP3 content for learning a language, which are reproduced mainly in the mobile phone 350, based on information, such as the type of reproducing apparatus, which is provided via a metadata file. Thus, the user A 310 may transfer MP3 content for learning a language from the computer 340 to the mobile phone 350 from among the aligned and output plurality of pieces of content.

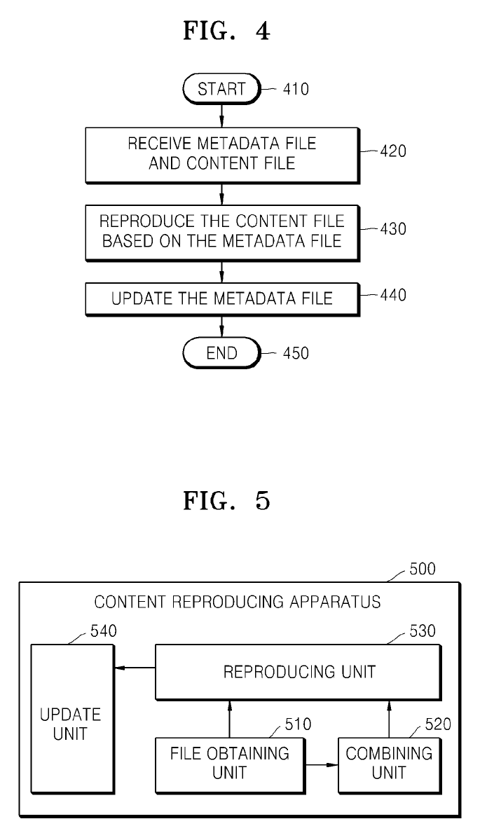

FIG. 4 is a flowchart illustrating a method of reproducing content by using metadata according to an exemplary embodiment.

In operation 420, the content reproducing apparatus 500 of FIG. 5 obtains a metadata file that includes at least one of learned content reproduction pattern information and reproduction management information, and a content file from either a content providing server or a content providing medium. As multimedia contents can be obtained in various ways, the content reproducing apparatus 500 may obtain the metadata file and the content file from another content reproducing apparatus. The content reproducing apparatus 500 may also obtain the metadata file from a content providing server that provides the content file or from another server.

In an exemplary embodiment, when the content reproducing apparatus 500 obtains a plurality of metadata files related to the same content file from the content providing server or the content providing medium, the metadata files may be combined into a single metadata file in order to accumulate information regarding the content file.

The single metadata file includes at least one of information regarding content reproduction environments of respective users and the users' evaluation of content, as the learned content reproduction pattern information, and includes at least one of bookmark information regarding a specific point or section of the content and significant chapter information of the content, and direct access information indicating a point of the content that was last reproduced, as the reproduction management information. In an exemplary embodiment, the metadata file is described using an ISO-based file format but the exemplary embodiment is not limited thereto.

The metadata file and the content file exist separately from each other but both include reference information referring to each other. In an exemplary embodiment, the identification or a URL of either the metadata file or the content file may be used as the reference information but the exemplary embodiment is not limited thereto.

In operation 430, the content reproducing apparatus 500 reproduces the content file based on at least one of the learned content reproduction pattern information and the reproduction management information included in the metadata file.

In operation 440, after reproducing the content file, the content reproducing apparatus 500 updates the metadata file to reflect at least one of the content reproduction pattern information and the reproduction management information related to the reproducing of the content file.

Also, the content reproducing apparatus 500 may provide the updated metadata file to at least one of the content providing server and another content reproducing apparatus, or may store the updated metadata file in the content providing medium in order to allow a user to share the updated metadata file with other users.

In an exemplary embodiment, the content reproducing apparatus 500 may generate the metadata file that includes at least one of the learned content reproduction pattern information and the reproduction management information. In this case, the generated metadata file may be provided to either at least one of the content providing server and another content reproducing apparatus, or the content providing medium.

FIG. 5 is a block diagram of the content reproducing apparatus 500 that reproduces content by using metadata according to an exemplary embodiment. The content reproducing apparatus 500 includes a file obtaining unit 510, a combining unit 520, a reproducing unit 530, and an update unit 540.

The file obtaining unit 510 obtains a metadata file that includes at least one of learned content reproduction pattern information and reproduction management information, and a content file from either a content providing server or a content providing medium. As multimedia contents can be obtained in various ways, the file obtaining unit 510 may obtain the metadata file and the content file from another content reproducing apparatus. The file obtaining unit 510 may also obtain the metadata file from a content providing server that provides the content file or from another server.

If the file obtaining unit 510 obtains a plurality of metadata files related to the same content file from the content providing server or the content providing medium, the combining unit 520 may combine the metadata files into a single metadata file.

The reproducing unit 530 reproduces the content file based on at least one of the learned content reproduction pattern information and the reproduction management information included in the metadata file.

The update unit 540 updates the metadata file to reflect at least one of the content reproduction pattern information and the reproduction management information.

The content reproducing apparatus 500 may further include a sharing unit (not shown) that provides the updated metadata file to at least one of the content providing server and another content reproducing apparatus, or stores the updated metadata file in the content providing medium.

The content reproducing apparatus 500 may further include a generation unit (not shown) and a transmission unit (not shown). The generation unit may generate the metadata file that includes at least one of the learned content reproduction pattern information and the reproduction management information. In this case, a transmission unit may transmit the generated metadata file to either at least one of the content providing server and another content reproducing apparatus, or the content providing medium.

The above exemplary embodiments may be embodied as a computer program. The computer program may be stored in a computer readable recording medium, and executed using a general digital computer. Examples of the computer readable recording medium include a magnetic recording medium (a ROM, a floppy disc, a hard disc, etc.), and an optical recording medium (a CD-ROM, a DVD, etc.).

The foregoing exemplary embodiments are merely exemplary and are not to be construed as limiting the scope of the claims. Various changes in form and details will be apparent to those of ordinary skill in the art.

What is claimed is:

1. A method of reproducing content, the method comprising:
obtaining a metadata file and a content file, wherein the metadata file comprises at least one of learned content reproduction pattern information and reproduction management information;
reproducing the content file based on the at least one of the learned content reproduction pattern and the reproduction management information of the metadata file; and
updating the metadata file based on the at least one of the learned content reproduction pattern information and the reproduction management information.

2. The method of claim 1, wherein the obtaining the metadata file and the content file comprises obtaining the metadata file and the content file from a content providing server or a content providing medium.

3. The method of claim 1, further comprising:
obtaining another metadata file related to the content file; and
combining the metadata file and the other metadata file into a single metadata file.

4. The method of claim 1, wherein the learned content reproduction pattern information comprises at least one of:
information regarding content reproduction environments; and
information regarding an evaluation of content in the content file.

5. The method of claim 1, wherein the reproduction management information comprises at least one of:
bookmark information regarding a specific point or section of content in the content file, significant chapter information of the content in the content file; and
direct access information indicating a point of the content that was most recently reproduced.

6. The method of claim 1, wherein the metadata file is described using an International Standardization Organization file format.

7. The method of claim 1, wherein the metadata file and the content file exist separately from each other, and both the metadata file and the content file comprises reference information referring to each other.

8. The method of claim 7, wherein the reference information comprises identification information or a uniform resource locator of the metadata file or the content file.

9. The method of claim 2, further comprising providing the updated metadata file to at least one of the content providing server, another content reproducing apparatus, and the content providing medium.

10. The method of claim 1, further comprising generating the metadata file that includes at least one of the learned content reproduction pattern information and the reproduction management information.

11. The method of claim 10, further comprising transmitting the generated metadata file to at least one of the content providing server, another content reproducing apparatus, and the content providing medium.

12. An apparatus for reproducing contents, the apparatus comprising:
a file obtaining unit that obtains a metadata file and a content file, wherein the metadata file comprises at least one of learned content reproduction pattern information and reproduction management information;
a reproducing unit that reproduces the content file based on the at least one of the learned content reproduction pattern information and the reproduction management information of the metadata file; and
an update unit that updates the metadata file based on the at least one of the learned content reproduction pattern information and the reproduction management information.

13. The apparatus of claim 12, wherein the obtaining unit obtains the metadata file and the content file from a content providing server or a content providing medium

14. The apparatus of claim 12, wherein the file obtaining unit obtains another metadata file related to the content file,
the apparatus further comprising a combining unit that combines the metadata file and the other metadata file into a single metadata file.

15. The apparatus of claim 12, wherein the learned content reproduction pattern information comprises at least one of:
information regarding content reproduction environments; and
information regarding an evaluation of content in the content file.

16. The apparatus of claim 12, wherein the reproduction management information comprises at least one of:
bookmark information regarding a specific point or section of content in the content file, significant chapter information of the content in the content file; and
direct access information indicating a point of the content that has been most recently reproduced

17. The apparatus of claim 12, wherein the metadata file is described using an International Standardization Organization file format.

18. The apparatus of claim 12, wherein the metadata file and the content file exist separately from each other, and both the metadata file and the content file comprise reference information referring to each other.

19. The apparatus of claim 18, wherein the reference information comprises identification information or a uniform resource locator of either the metadata file or the content file.

20. The apparatus of claim 13, further comprising a sharing unit that provides the updated metadata file to at least one of the content providing server, another content reproducing apparatus, and the content providing medium.

21. The content-reproducing apparatus of claim 12, further comprising a generation unit that generates the metadata file that includes at least one of the learned content reproduction pattern information and the reproduction management information.

22. The apparatus of claim 21, further comprising a transmission unit that transmits the generated metadata file to at least one of the content providing server, another content reproducing apparatus, and the content providing medium.

23. A computer readable recording medium having recorded thereon a computer program that when executed by a computer causes the computer to perform the method of claim 1.
